(19) United States
(12) Patent Application Publication
(10) Pub. No.: US 2015/0290830 A1
(43) Pub. Date: Oct. 15, 2015

(54) Tool Coupling Device

(71) Applicant: Robert Bosch GmbH, Stuttgart (DE)

(72) Inventors: Jens Zieger, Altbach (DE); Uwe Engelfried, Ostfildern (DE); Petr Grulich, Kirchheim/Teck (DE); Thomas Duerr, Asperg (DE)

(21) Appl. No.: 14/409,040

(22) PCT Filed: May 14, 2013
(86) PCT No.: PCT/EP2013/059930

§ 371 Date: Dec. 18, 2014

(30) Foreign Application Priority Data
Jun. 28, 2012 (DE) 10 2012 211 096.8

(51) Int. Cl. B27B 17/14; B27B 17/02

(52) U.S. Cl. CPC B27B 17/14; B27B 17/02

(57) ABSTRACT

A tool coupling device is configured to hold a machine tool cutting device. In particular, the tool coupling device is configured to hold a machine tool cutting device configured as a closed system, having at least one cutting train clamping unit for generating a cutting train clamping force and having at least one tool-holding unit comprising at least one movably mounted tool-holder element. The tool coupling device includes at least one movement-coupling unit by which the tool-holder element can be coupled with a clamping element for a movement of the clamping element of the cutting train clamping unit.

### PRIOR ART

There are already known tool coupling devices for receiving a power-tool parting device realized as a closed system, which have a cutting-strand tensioning unit for generating a cutting-strand tensioning force, and which have a tool holding unit that comprises a movably mounted tool holding element.

### DISCLOSURE OF THE INVENTION

The invention is based on a tool coupling device for receiving a power-tool parting device, in particular a power-tool parting device realized as a closed system, having at least one cutting-strand tensioning unit for generating a cutting-strand tensioning force, and having at least one tool holding unit that comprises at least one movably mounted tool holding element.

It is proposed that the tool coupling device comprise at least one movement coupling unit, by means of which, for the purpose of moving a tensioning element of the cutting-strand tensioning unit, the tool holding element can be coupled to the tensioning element. The tensioning element is thus preferably connected to the tool holding element in a motionally dependent manner, via the movement coupling unit, in at least one movement direction. The tool coupling device is preferably provided to receive the power-tool parting device in a form-closed and/or force-closed manner, or to fix the power-tool parting device to a main body of the tool coupling device by means of a form-closed and/or by means of a force-closed connection, by means of the tool holding unit. “Provided” is to be understood to mean, in particular, specially programmed, designed and/or equipped. For the purpose of fixing the power-tool parting device to the main body, the tool holding element preferably exerts a clamping force upon a guide unit of the power-tool parting device, in the direction of the main body. Preferably, for the purpose of transmitting drive forces to the power-tool parting device, the power-tool parting device is received by the tool coupling device, or fixed to the main body of the tool coupling device. The tool holding element in this case preferably exerts a holding force upon the power-tool parting device, at least in one state, in particular in at least one state in which the power-tool parting device is connected to the tool coupling device. The tool holding element preferably fixes the power-tool parting device to the main body of the tool coupling device by means of a form-closed and/or by means of a force-closed connection. Particularly preferably, the tool holding element is provided to generate a holding force in at least one tool fixing position of the tool holding element. Moreover, the tool holding element is provided to actuate the cutting-strand tensioning unit by means of the movement coupling unit.

Preferably, the tool holding element is mounted such that it can be swiveled about an axis of motion of the tool holding element that is at least substantially parallel to a plane of main extent of the tool holding element. “Substantially parallel” is to be understood here to mean, in particular, an alignment of a direction relative to a reference direction, in particular in one plane, the direction deviating from the reference direction by, in particular, less than 8°, advantageously less than 5°, and particularly advantageously less than 2°. The term “plane of main extent” is intended here to define, in particular, a plane in which the tool holding element has a maximum extent. Preferably in this case, the tool holding element can be swiveled by a swivel angle that, in particular, is greater than 5°, preferably greater than 45°, and particularly preferably greater than 75°. Preferably, the plane of main extent of the tool holding element, in a tool holding element swiveled fully into an open position, is at least substantially parallel to a rotation axis of a drive element that is mounted in a rotatable manner in the main body of the tool coupling device. Preferably in this case, the axis of motion of the tool holding element is at least substantially perpendicular to a rotation axis of the drive element of the tool coupling device, or of a portable power tool comprising the tool coupling device, that is mounted in a rotatable manner in the main body of the tool coupling device. The expression “substantially perpendicular” is intended here to define, in particular, an alignment of a direction relative to a reference direction, wherein the direction and the relative direction, in particular as viewed in one plane, enclose an angle of 90° and the angle has a maximum deviation of, in particular, less than 8°, advantageously less than 5°, and particularly advantageously less than 2°. In an alternative design of the tool coupling device according to the invention, the tool holding element is preferably mounted such that it can rotate about an axis of motion of the tool holding element that is at least substantially perpendicular to a plane of main extent of the tool holding element. Preferably, the plane of main extent of the tool holding element extends at least substantially perpendicularly in relation to the rotation axis of the drive element.

The term “cutting-strand tensioning unit” is intended here to define, in particular, a unit provided to exert a tensioning force upon the cutting strand, for the purpose of tensioning, or pretensioning, a cutting strand of the power-tool parting device, at least in a state in which the power-tool parting device has been connected to the tool coupling device. The tensioning element in this case is preferably mounted on the main body of the tool coupling device so as to be movable relative to the main body of the tool coupling device. Particularly preferably, the tensioning element is mounted in a translationally movable manner. The expression “mounted in a translationally movable manner” is intended here to define, in particular, a mounting of a unit and/or of an element relative to at least one other unit and/or one other element, the unit and/or the element, in particular dissociated from an elastic deformation of the unit and/or element, and dissociated from movement capabilities caused by a bearing clearance, having a capability to move along at least one axis, along a travel distance greater than 1 mm, preferably greater than 5 mm, and particularly preferably greater than 10 mm. Advantageously, the design according to the invention makes it possible to achieve a tool coupling device that is easy to operate. Advantageously, by means of the cutting-strand tensioning unit, an automatic tensioning operation can be realized by actuation of the tool holding element. It is thus possible, advantageously, to achieve a holding force for fixing a power-tool parting device to the main body of the tool coupling device and, at the same time, tensioning of the cutting strand of the power-tool parting device fixed to the tool coupling device.

Furthermore, it is proposed that the movement coupling unit have at least one gate element for moving the tensioning element as a result of a movement of the tool holding element. A “gate element” is to be understood here to mean, in particular, an element having at least one recess, in particular a slot, in which there engages a further element that corresponds to the element, and/or which has at least one extension that engages in a recess of a further element that corresponds to the element, a constrained movement of the further element being effected, in dependence on a geometric shape of the recess, as a result of a movement of the element. Preferably, the gate element is realized as a gate disk or as a gate translation element. Preferably, the tensioning element engages in the recess of the gate element. Preferably, the movement coupling unit has at least one spring element, which is provided to apply a spring force to the tensioning element and/or to the gate element. A “spring element” is to be understood to mean, in particular, a macroscopic element having at least two ends that are spaced apart from each other and that, in a normal tool holding state, can be moved elastically relative to each other along a movement distance, the movement distance being at least greater than 0.5 mm, in particular greater than 1 mm, preferably greater than 2 mm, and particularly advantageously greater than 3 mm, and that, in particular, generates a counter-force, which is dependent on an elastic movement of the ends relative to each other and preferably proportional to the elastic movement of the ends relative to each other, and which counteracts the variation. A “macroscopic element” is to be understood to mean, in particular, an element having an extent of at least 1 mm, in particular of at least 5 mm, and preferably of at least 10 mm. The spring element in this case may be realized as a tension spring, as a compression spring, as a torsion spring, as a spiral spring, etc. Particularly preferably, the spring element is realized as a helical compression spring or as a leg spring. It is also conceivable, however, for the spring element to be of different design, considered appropriate by persons skilled in the art. The design of the tool coupling device according to the invention makes it possible, by simple design means, to achieve movement of the tensioning element in dependence on a movement of the tool holding element. Moreover, advantageously, the tensioning element can be biased to at least one tool holding position, in particular to a tensioning position, by means of the spring element.

Furthermore, it is proposed that the gate element be mounted in a translationally movable manner.

Preferably, the gate element has an axis of motion that is at least substantially perpendicular to the rotation axis of the drive element. Preferably, the gate element is guided translationally by two linear guide elements of the movement coupling unit that are at least substantially parallel to each other. Advantageously, the design of the tool coupling device according to the invention enables the gate element to be guided in a precise manner.

In addition, in an alternative design of the tool coupling device, it is proposed that the gate element be mounted in a rotatable manner. Preferably, the gate element has an axis of motion that is at least substantially parallel to the rotation axis of the drive element. Advantageously, it is possible to achieve a movement coupling unit designed to have a flat structure. Thus, advantageously, a compact tool coupling device can be achieved.

Furthermore, it is proposed that the movement coupling unit comprise at least one lever element, by means of which the tool holding element can be coupled to a gate element of the movement coupling unit for the purpose of moving the tensioning element. A “lever element” is to be understood here to mean, in particular, an element mounted such that it can be swiveled at least about an axis of motion of the element and that, in particular, has a maximum extent along a direction that is at least substantially perpendicular to the axis of motion, in order to realize at least one lever arm.

Preferably, the lever element is realized as a two-sided lever element that, as viewed in two opposing directions, out from the axis, or from a rotation point, realizes a load arm and a power arm, respectively. It is conceivable for the movement coupling unit to have a multiplicity of lever elements that act in combination with each other, or are connected to each other, for the purpose of moving the tensioning element as a result of a movement of the tool holding element. Advantageously, by means of the design according to the invention, a stepped-up force can be produced for the purpose of moving the tensioning element. Thus, advantageously, a small actuating force, applied by an operator to actuate the tool holding element, can be stepped up to a large actuating force of the tensioning element.

Moreover, in an alternative design of the tool coupling device, it is proposed that the movement coupling unit comprise at least one eccentric element, which is realized so as to be integral with the tool holding element. An “eccentric element” is to be understood here to mean, in particular, an element mounted such that it can be swiveled at least about an axis of motion of the element, a mid-point, in particular a symmetry mid-point, of the element being disposed outside of the axis of motion. The eccentric element in this case may be directly or indirectly coupled to the tensioning element. “Integral with” is to be understood to mean, in particular, connected at least by adhesive force, for example by a welding process, an adhesive bonding process, an injection process and/or another process considered appropriate by persons skilled in the art, and/or, advantageously, formed in one piece such as, for example, by being produced from a casting and/or by being produced in a single or multi-component injection process and, advantageously, from a single blank. Advantageously, a movement of the operating element can be converted to a movement of the tensioning element.

It is additionally proposed that the tool holding unit have at least one fixing element provided to fix the tool holding element in at least one position. Advantageously, unintentional movement of the tool holding element can be prevented as a result. Preferably, the fixing element is mounted in a swiveling manner. It is also conceivable, however, for the fixing element to be mounted in a translationally movable manner. The design according to the invention makes it possible, advantageously, to make use of a lever principle for actuation of the fixing element. A fixing element that is easy to operate can thus be achieved.

The invention is additionally based on a portable power tool comprising a tool coupling device according to the invention. The tool coupling device is preferably provided for form-closed and/or force-closed coupling to a power-tool parting device. A “portable power tool” is to be understood here to mean, in particular, a power tool, in particular a hand power tool, that can be transported by an operator without the use of a transport machine. The portable power tool has, in particular, a mass of less than 40 kg, preferably less than 10 kg, and particularly preferably less than 5 kg. Advantageously, it is possible to achieve a portable power tool on which a power-tool parting device can be arranged in a particularly convenient manner.

The invention is additionally based on a power tool system comprising a power tool according to the invention, and comprising a power-tool parting device, which has at least one cutting strand and has at least one guide unit that, together with the cutting strand, forms a closed system. A “cutting strand” is to be understood here to mean, in particular, a unit provided to locally undo an atomic coherence of a workpiece on which work is to be performed, in particular by means of a mechanical parting-off and/or by means of a mechanical removal of material particles of the workpiece. Preferably, the cutting strand is provided to separate the workpiece into at least two parts that are physically separate from each other, and/or to part off and/or remove, at least partially, material particles of the workpiece, starting from a surface of the workpiece. The cutting strand is preferably realized as a cutting chain. It is also conceivable, however, for the cutting strand to be of another design, considered appropriate by persons skilled in the art, such as, for example, designed as a cutting cord, to which cutting elements are fixed. The expression “guide unit” is intended here to define, in particular, a unit provided to exert a constraining force upon the cutting strand, at least along a direction perpendicular to a cutting direction of the cutting strand, in order to define a movement capability of the cutting strand along the cutting direction. A “cutting direction” is to be understood here to mean, in particular, a direction along which the cutting strand is moved, in at least one operating state, as a result of a driving force and/or a driving torque, in particular in the guide unit, for the purpose of producing a cut and/or parting-off and/or removing material particles of a workpiece on which work is to be performed. Preferably, the cutting strand, when in an operating state, is moved, relative to the guide unit, along the cutting direction. The term “closed system” is intended here to define, in particular, a system comprising at least two components that, by means of combined action, when the system has been demounted from a system, in particular the tool coupling device, that is of a higher order than the system, maintain a functionality and/or are inseparably connected to each other when in the demounted state. Preferably, the at least two components of the closed system are connected to each other so as to be at least substantially inseparable by an operator. “At least substantially inseparable” is to be understood here to mean, in particular, a connection of at least two components that can be separated from each other only with the aid of parting tools such as, for example, a saw, in particular a mechanical saw, etc. and/or chemical parting means such as, for example, solvents, etc.

In particular, the power-tool parting device, as viewed along a direction that is at least substantially perpendicular to a cutting plane of the power-tool parting device, has a maximum dimension of less than 10 mm, preferably less than 8 mm, and particularly preferably less than 5 mm. Preferably, the dimension is realized as the width of the power-tool parting device. Particularly preferably, the power-tool parting device, as viewed along the direction that is at least substantially perpendicular to the cutting plane of the power-tool parting device, has a maximum dimension that is at least substantially constant along a total length of the power-tool parting device. The power-tool parting device is thus preferably provided to produce a cut that has a maximum dimension of less than 5 mm, as viewed along the direction that is at least substantially perpendicular to the cutting plane of the power-tool parting device. The design according to the invention makes it possible, advantageously, to achieve a power tool system that can be adapted in a particularly convenient manner to differing fields of application in that, advantageously, the power-tool parting device can be removed from the tool coupling device.

The tool coupling device according to the invention, the portable power tool according to the invention and/or the power tool system according to the invention is/are not intended in this case to be limited to the application and embodiment described above. In particular, the tool coupling device according to the invention, the portable power tool according to the invention and/or the power tool system according to the invention may have individual elements, components and units that differ in number from the number stated herein, in order to fulfill a principle of function described herein.

### DRAWING

Further advantages are given by the following description of the drawing. The drawing shows exemplary embodiments of the invention. The drawing, the description and the claims contain numerous features in combination. Persons skilled in the art will also expediently consider the features individually and combine them to create appropriate further combinations.

There are shown in the drawing:

FIG. 1 a portable power tool according to the invention, having a tool coupling device according to the invention, in a schematic representation,

FIG. 2 a detail view of the tool coupling device according to the invention, in a schematic representation,

FIG. 3 a sectional view of the tool coupling device according to the invention, in a schematic representation,

FIG. 4 a detail view of a movement coupling element of a movement coupling unit of the tool coupling device according to the invention, in a schematic representation,

FIG. 5 a side view of the tool coupling device according to the invention, with a power-tool parting device disposed in the tool coupling device according to the invention, in a schematic representation,

FIG. 6 a further side view of the tool coupling device according to the invention, with the power-tool parting device disposed in the tool coupling device according to the invention, in a schematic representation,

FIG. 7 a detail view of an alternative tool coupling device according to the invention, in a schematic representation,

FIG. 8 a sectional view of the alternative tool coupling device according to the invention, in a schematic representation,

FIG. 9 an exploded view of the alternative tool coupling device according to the invention, in a schematic representation,

FIG. 10 a detail view of a further, alternative tool coupling device according to the invention, in a schematic representation,

FIG. 11 a further detail view of the further, alternative tool coupling device according to the invention, in a schematic representation,

FIG. 12 a sectional view of the further, alternative tool coupling device according to the invention, in a schematic representation,

FIG. 13 a detail view of a further, alternative tool coupling device according to the invention, in a schematic representation,

FIG. 14 a sectional view of the further, alternative tool coupling device according to the invention from FIG. 13, in a schematic representation,

FIG. 15 a detail view of a further, alternative tool coupling device according to the invention, in a schematic representation,

FIG. 16 a further detail view of the further, alternative tool coupling device according to the invention from FIG. 15, in a schematic representation,

FIG. 17 a detail view of a further, alternative tool coupling device according to the invention, in a schematic representation,

FIG. 18 a further detail view of the further, alternative tool coupling device according to the invention from FIG. 17, in a schematic representation,

FIG. 19 a detail view of a further, alternative tool coupling device according to the invention, in a schematic representation,

FIG. 20 a further detail view of the further, alternative tool coupling device according to the invention from FIG. 19, in a schematic representation,

FIG. 21 a sectional view of the further, alternative tool coupling device according to the invention from FIG. 19, in a schematic representation.

### DESCRIPTION OF THE EXEMPLARY EMBODIMENTS

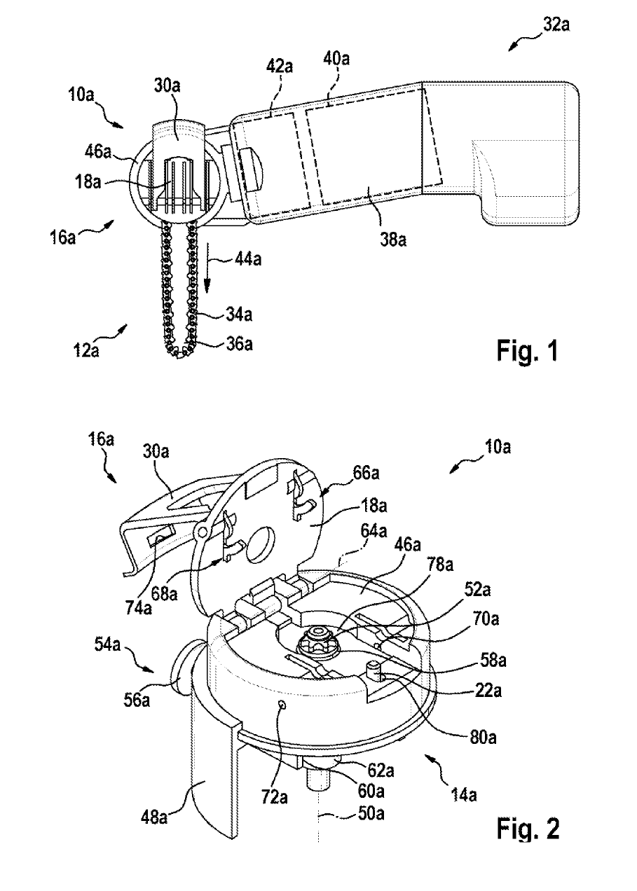

FIG. 1 shows a portable power tool 32a, having a power-tool parting device 12a disposed on a tool coupling device 10a of the portable power tool 32a. The portable power tool 32a and the power-tool parting device 12a together form a power tool system. The power-tool parting device 12a comprises at least one cutting strand 34a, and at least one guide unit 36a for guiding the cutting strand 34a. The guide unit 36a and the cutting strand 34a together form a closed system. The power-tool parting device 12a is thus realized as a closed system. The portable power tool 32a has the tool coupling device 10a for coupling the power-tool parting device 12a in a form-closed and/or force-closed manner. The tool coupling device 10a is provided to receive the power-tool parting device 12a realized as a closed system. The tool coupling device 10a in this case comprises at least one cutting-strand tensioning unit 14a, for generating a cutting-strand tensioning force, and at least one tool holding unit 16a, which comprises at least one movably mounted tool holding element 18a.

Moreover, the portable power tool 32a has a power-tool housing 38a, which encloses a drive unit 40a and an output transmission unit 42a of the portable power tool 32a. The drive unit 40a and the output transmission unit 42a are operatively connected to each other, in a manner already known to persons skilled in the art, for the purpose of generating a drive torque that can be transmitted to the power-tool parting device 12a. The output transmission unit 42a is realized as a bevel gear transmission. The drive unit 40a is realized as an electric motor unit. It is also conceivable, however, for the drive unit 40a and/or the output transmission unit 42a to be of a different design, considered appropriate by persons skilled in the art, such as, for example, the drive unit 40a being designed as a hybrid drive unit or as an internal combustion drive unit, etc., and/or the output transmission unit 42a being designed as a worm gear transmission, etc. The drive unit 40a is provided to drive the cutting strand 34a of the power-tool parting device 12a, in at least one operating state, via the output transmission unit 42a. The cutting strand 34a in this case is moved in the guide unit 36a of the power-tool parting device 12a, along a cutting direction 44a of the cutting strand 34a, relative to the guide unit 36a.

FIG. 2 shows the tool coupling device 10a demounted from the portable power tool 32a. The tool coupling device 10a comprises a main body 46a, which is mounted in a rotatable manner in a connection housing 48a of the tool coupling device 10a. The main body 46a in this case is mounted in the connection housing 48a so as to be rotatable about a rotation axis 50a of a drive element 52a of the tool coupling device 10a. When the tool coupling device 10a is mounted on the portable power tool 32a, the connection housing 48a is fixed to the power-tool housing 38a of the portable power tool 32a. The tool coupling device 10a has at least one rotary positioning unit 54a, for fixing a rotary position of the main body 46a relative to the connection housing 48a. The rotary positioning unit 54a in this case comprises at least one positioning element 56a, for fixing the main body 46a in a position relative to the connection housing 48a. The positioning element 56a in this case is realized as a spring-biased locking pin, which acts in combination with positioning recesses (not represented in greater detail here) of the main body 46a, in a manner already known to persons skilled in the art. It is also conceivable, however, for the rotary positioning unit 54a to be of a different design, considered appropriate by persons skilled in the art, such as, for example, designed as tooth system.

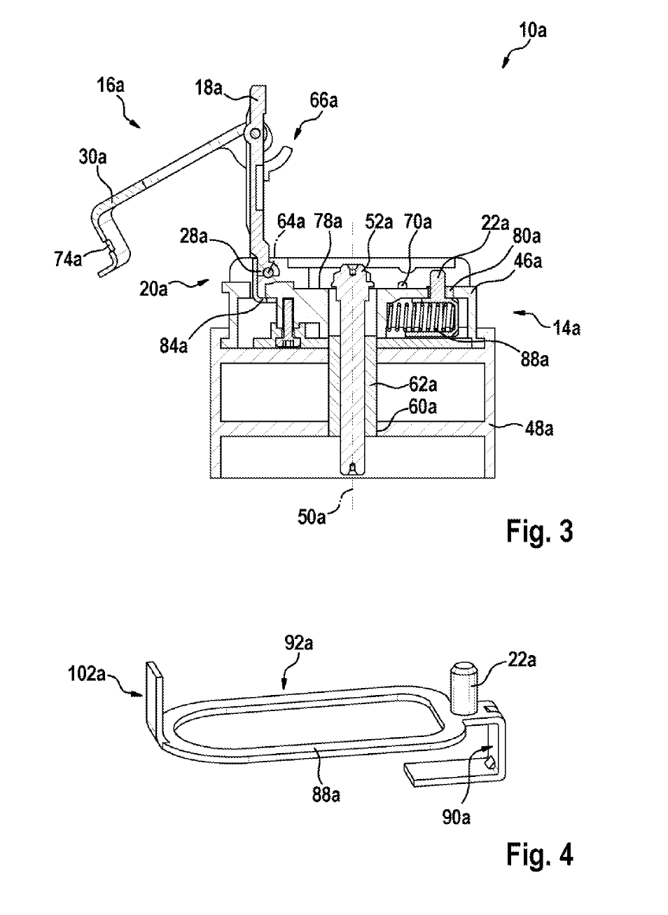

The main body 46a additionally has a rotary play opening 58a (FIG. 3), in which the drive element 52a of the tool coupling device 10a is disposed. In this case, the drive element 52a, as viewed along a direction that is at least substantially perpendicular to the rotation axis 50a of the drive element 52a, is disposed, relative to the main body 46a, at a distance from an edge region of the main body 46a that delimits the rotary play opening 58a. The drive element 52a is realized as a driving toothed wheel. The connection housing 48a comprises a bearing recess 60a, in which there is disposed a bearing element 62a of the tool coupling device 10a, for rotatably mounting the drive element 52a. The bearing element 62a is realized as a bearing sleeve. It is also conceivable, however, for the bearing element 62a to be realized as a rolling bearing. The drive element 52a is provided to transmit a driving force of the drive unit 40a to the cutting strand 34a. Thus, when power-tool parting device 12a is connected to the tool coupling device 10a, the drive element 52a engages in the cutting strand 34a. The drive element 52a in this case engages in drive recesses of cutting strand segments of the cutting strand 34a (not represented in greater detail here). In addition, when the tool coupling device 10a is mounted on the portable power tool 32a, the drive element 52a is connected to an output element (not represented in greater detail here) of the output transmission unit 42a in a rotationally fixed manner.

Furthermore, the tool holding element 18a of the tool holding unit 16a of the tool coupling device 10a is mounted such that it can swivel about an axis of motion 64a of the tool holding element 18a that is at least substantially parallel to a plane of main extent of the tool holding element 18a. The tool holding element 18a in this case is mounted in a swiveling manner on the main body 46a. The axis of motion 64a of the tool holding element 18a, as viewed in a plane of projection into which the axis of motion 64a and the rotation axis 50a of the drive element 52a are projected, is at least substantially perpendicular to the rotation axis 50a. The tool holding element 18a is mounted such that it can swivel by less than 120° relative to the main body 46a. It is also conceivable, however, for the tool holding element 18a to be mounted such that it can swivel by an angle other than 90° relative to the main body 46a.

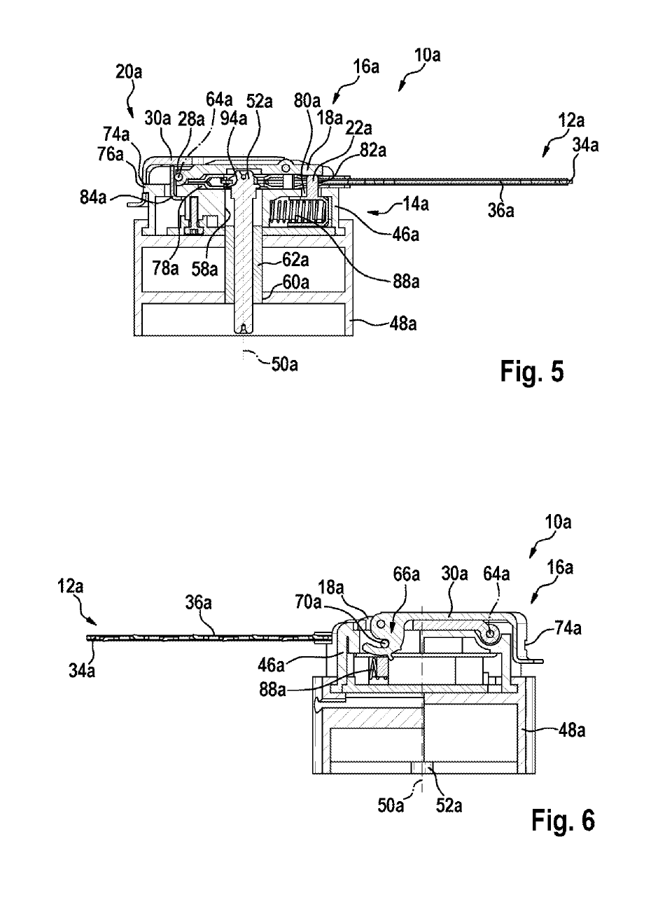

The tool holding unit 16a additionally has at least one fixing element 30a provided to fix the tool holding element 18a in at least one position. The fixing element 30a is provided to fix the tool holding element 18a in a tool fixing position of the tool holding element 18a. For this purpose, the fixing element 30a is mounted in a swiveling manner. The fixing element 30a in this case is mounted in a swiveling manner on the tool holding element 18a. The fixing element 30a comprises at least two latching regions 66a, 68a. It is also conceivable, however, for the fixing element 30a to have a number of latching regions 66a, 68a other than two. The latching regions 66a, 68a, as viewed in a plane that is at least substantially perpendicular to the plane of main extent of the tool holding element 18a, or as viewed in a plane that is at least substantially parallel to the rotation axis 50a of the drive element 52a, are arcuate in form and each delimit an arcuate latching recess. Moreover, when the fixing element 30a is in an operating-element fixing position, the latching regions 66a, 68a act in combination with fixing studs 70a, 72a of the tool holding unit 16a (FIG. 6). The fixing studs 70a, 72a are fixed to the main body 46a. The fixing element 30a is thus provided to fix the tool holding element 18a in the tool fixing position by means of a form-closed connection. For the purpose of securing the fixing element 30a in the tool-holding element fixing position, the fixing element 30a additionally has a securing recess 74a, which acts in combination with a latching extension 76a of the tool holding unit 16a when the fixing element 30a is in the tool-holding element fixing position (FIG. 5). The latching extension 76a in this case is disposed on the main body 46a. The latching extension 76a in this case is integrally formed on to the main body 46a. It is also conceivable, however, for the latching extension 76a to be realized separately from the main body 46a, and to be fastened to the main body 46a by means of a fastening element considered appropriate by persons skilled in the art.

When the power-tool parting device 12a is coupled to the tool coupling device 10a, the power-tool parting device 12a, in particular the guide unit 36a, in the tool fixing position, is subjected to a clamping force in the direction of the main body 46a by means of the tool holding element 18a, in a receiving recess 78a of the main body 46a. This clamping force is generated by means of a swivel movement of the tool holding element 18a in the direction of the receiving recess 78a and by means of a combined action of the fixing element 30a and the fixing studs 70a, 72a when the tool holding element 18a is in the tool fixing position. When the tool holding element 18a is in a tool fixing position, the tool holding element 18a, for the purpose of generating a holding force in the direction of the main body 46a, bears against an outer face of the guide unit 36a. The tool holding element 18a holds the power-tool parting device 12a, in particular the guide unit 36a, in the tool fixing position of the tool holding element 18a as the result of a clamping force in the receiving recess 78a of the main body 46a. The tool holding unit 16a is thus provided to act upon the power-tool parting device 12a, when the power-tool parting device 12a is coupled to the tool coupling device 10a, in a direction that is at least substantially parallel to the rotation axis 50a of the drive element 52a. It is also conceivable, however, for the tool holding unit 16a to be of a different design, considered appropriate by persons skilled in the art.

Moreover, when the power-tool parting device 12a is coupled to the tool coupling device 10a, the power-tool parting device 12a is secured in a form-closed manner, by means of the receiving recess 78a of the main body 46a, against a rotational movement along a direction of rotation about the rotation axis 50a of the drive element 52a. The receiving recess 78a thus constitutes at least one power-tool parting-device torque holding element of a power-tool parting-device torque holding unit. For this purpose, the receiving recess 78a has a shape that corresponds to an external shape of at least one partial region of the power-tool parting device 12a, in particular a partial region of the guide unit 36a. The receiving recess 78a is thus realized as a negative shape of at least one partial region of the power-tool parting device 12a, in particular a partial region of the guide unit 36a. It is also conceivable, however, for the main body 46a to be of another design, considered appropriate by persons skilled in the art, that can prevent, insofar as possible, a rotational movement of the power-tool parting device 12a when the power-tool parting device 12a is coupled to the tool coupling device 10a.

Furthermore, the tool coupling device 10a comprises at least one movement coupling unit 20a, by means of which, for the purpose of moving a tensioning element 22a of the cutting-strand tensioning unit 14a, the tool holding element 18a can be coupled to the tensioning element 22a. The tensioning element 22a in this case is mounted in a translationally movable manner in a guide recess 80a of the main body 46a. The guide recess 80a is disposed in the receiving recess 78a. The tensioning element 22a is realized as a tensioning stud, which engages in a tensioning recess 82a (FIG. 5) of the power-tool parting device 12a when the power-tool parting device 12a is coupled to the tool coupling device 10a. The tensioning element 22a is realized so as to be integral with a movement coupling element 84a of the movement coupling unit 20a. It is also conceivable, however, for the tensioning element 22a to be realized so as to be separate from the movement coupling element 84a, and to be fixed to the movement coupling element 84a by means of a form-closed and/or force-closed connection. The movement coupling element 84a is mounted in a translationally movable manner in the main body 46a. In addition, the movement coupling element 84a comprises an actuating region 86a, which acts in combination with a transmission element of the movement coupling unit 20a for the purpose of moving the tensioning element 22a as a result of a movement of the tool holding element 18a. The transmission element of the movement coupling unit 20a in this case is realized as an eccentric element 28a (FIG. 3). The movement coupling unit 20a thus comprises at least the eccentric element 28a, which acts in combination with the tensioning element 22a for the purpose of moving the tensioning element 22a as a result of a movement of the tool holding element 18a, via the movement coupling element 84a. The eccentric element 28a is realized so as to be integral with the tool holding element 18a (FIG. 3). The eccentric element 28a is disposed on the tool holding element 18a, eccentrically, or asymmetrically, in relation to the axis of motion 64a of the tool holding element 18a.

Moreover, the cutting-strand tensioning unit 14a has at least one spring element 88a, which is provided to apply a spring force to the tensioning element 22a. The spring element 88a in this case is supported with one end on the main body 46a and, with another end, the spring element 88a is supported on a tensioning force support region 90a of the movement coupling element 84a. It is additionally conceivable that, for the purpose of supporting a tensioning force of the tensioning element 22a, the movement coupling element 84a an additional clamping and/or locking of the movement coupling element 84a on the main body 46a is possible, such as, for example, by a rough surface of the movement coupling element 84a or by a locking unit, etc. The tensioning force support region 90a and the actuating region 86a of the movement coupling element 84a in this case are connected to each other via a connecting region 92a of the movement coupling element 84a. The connecting region 92a has an elliptical shape (FIG. 4). When the tool holding element 18a is in a position in which it has been swiveled away from the main body 46a, the spring element 88a is compressed as a result of a combined action of the eccentric element 28a and the actuating region 86a of the movement coupling element 84a. As a result, the tensioning element 22a is moved into a guide-unit insertion position.

For the purpose of coupling the power-tool parting device 12a to the tool coupling device 10a, the power-tool parting device 12a is inserted in the receiving recess 78a of the main body 46a, along a direction that is at least substantially parallel to the rotation axis 50a of the drive element 52a. The tool holding element 18a in this case is disposed in the position in which it has been swiveled away from the main body 46a. As the power-tool parting device 12a is inserted in the receiving recess 78a, the drive element 52a is introduced into a coupling recess 94a of the guide unit 36a (FIG. 5). As a result, the cutting strand 34a engages with the drive element 52a. In addition, the tensioning element 22a is introduced into the tensioning recess 82a of the guide unit 36a.

As a result of the tool holding element 18a being moved into the tool fixing position, the eccentric element 28a releases the actuating region 86a of the movement coupling element 84a. The movement coupling element 84a, together with the tensioning element 22a, is thus moved by a spring force of the spring element 88a, translationally in a direction away from the drive element 52a, into a tensioning position of the tensioning element 22a. As a result, the guide unit 36a is moved relative to the drive element 52a. This causes the cutting strand 34a to be tensioned by the spring force of the spring element 88a, or by the movement of the tensioning element 22a. A cutting-strand tensioning force, for tensioning the cutting strand 34a, is achieved as a result. Thus, automatic tensioning of the cutting strand 34a is effected as a result of the power-tool parting device 12a being clamped in the receiving recess 78a of the main body 46a by means of the tool holding unit 16a. The power-tool parting device 12a, when coupled to the tool coupling device 10a, is thus clamped in the receiving recess 78a, between the tool holding element 18a and the main body 46a, by means of the tool holding unit 16a. Moreover, the fixing of the tool holding element 18a by means of the fixing element 30a results in self-locking of the cutting-strand tensioning unit 14a, in order to avoid unwanted removal of a cutting-strand tensioning force for tensioning the cutting strand 34a.

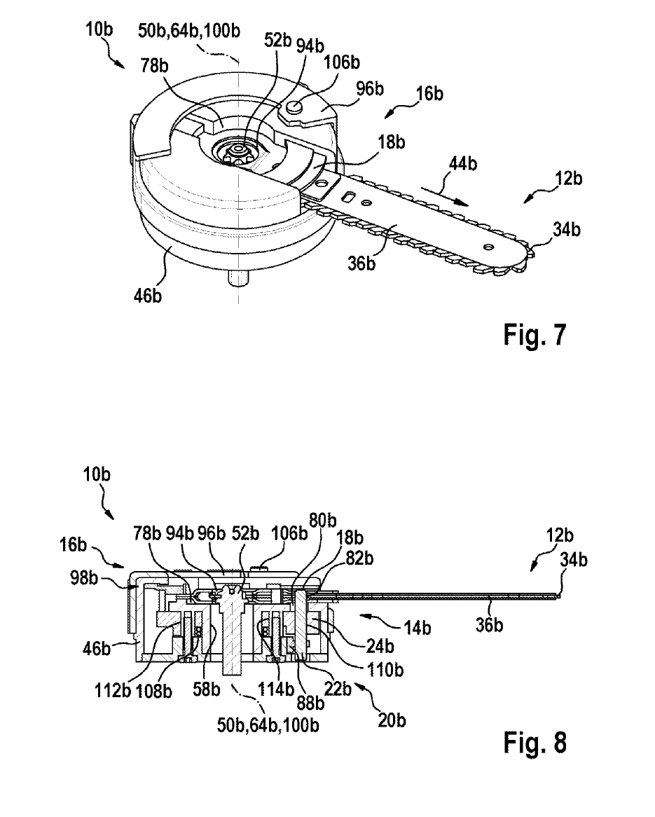

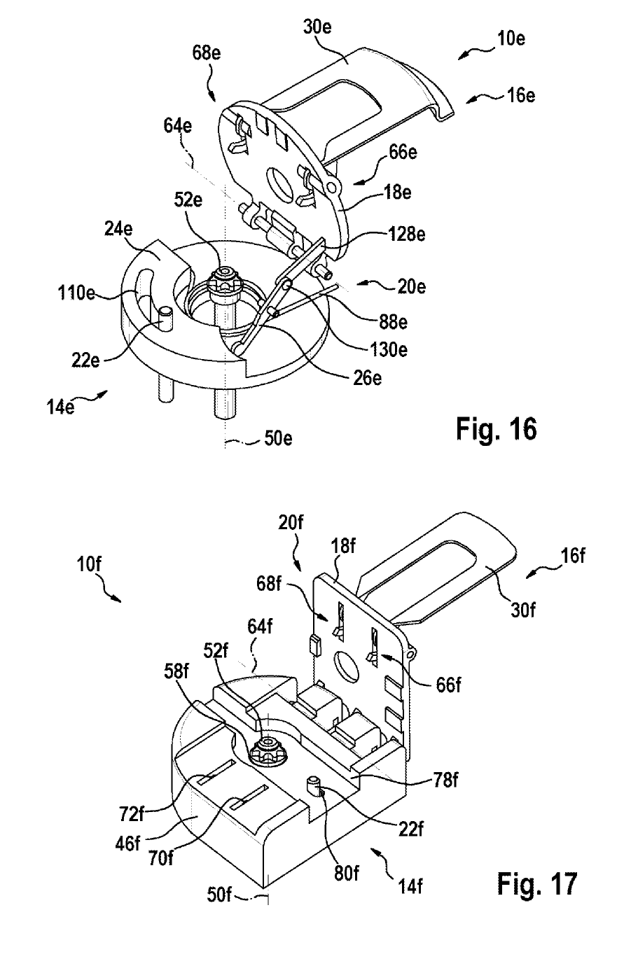

Alternative exemplary embodiments are represented in FIGS. 7 to 21. Components, features and functions that remain substantially the same are denoted basically by the same references. To differentiate the exemplary embodiments, the letters a to g have been appended to the references of the exemplary embodiments. The following description is limited substantially to the differences as compared with the first exemplary embodiment described in FIGS. 1 to 6, and reference may be made to the description of the first exemplary embodiment in FIGS. 1 to 6 in respect of components, features and functions that remain the same.

FIG. 7 shows an alternative tool coupling device 10b, which is provided to receive a power-tool parting device 12b realized as a closed system, demounted from a portable power tool (not represented in greater detail here). The portable power tool is of a design similar to that of the portable power tool 32a described in FIGS. 1 to 6. The portable power tool and the power-tool parting device 12b together form a power tool system. The tool coupling device 10b comprises at least one cutting-strand tensioning unit 14b, for generating a cutting-strand tensioning force, and at least one tool holding unit 16b, which has at least one movably mounted tool holding element 18b. The tool holding element 18b in this case is mounted so as to be rotatable about an axis of motion 64b of the tool holding element 18b that is at least substantially perpendicular to a plane of main extent of the tool holding element 18b, or about one that is at least substantially parallel to a rotation axis 50b of a drive element 52b of the tool coupling device 10b. The tool holding element 18b is provided to apply a clamping force to the power-tool parting device 12b, in the direction of a main body 46b of the tool coupling device 10b, when the tool holding element 18b is in a tool fixing position.

The tool holding element 18b is realized in the form of a circular-ring segment. In addition, the tool holding element 18b is mounted in a rotatable manner in the main body 46b. For the purpose of generating a clamping force, the tool holding element 18b has a tensioning region 98b in the shape of a spiral, or in the shape of a screw thread. The tensioning region 98b is disposed on an outer circumference of the tool holding element 18b. It is also conceivable, however, for the tensioning region 98b to be disposed at another position on the tool holding element 18b, considered appropriate by persons skilled in the art, such as, for example, on an inner circumference of the tool holding element 18b. The tensioning region 98b has a slope, as viewed along a circumferential direction extending around the rotation axis 50b of the drive element 52b. Along a total extent of the tensioning region 98b, therefore, the tensioning region 98b is sloped relative to a plane of main extent of the tool holding element 18b. The tensioning region 98b, for the purpose of generating a clamping force, acts in combination with a tensioning slot (not represented in greater detail here) of the main body 46b, in which the tensioning region 98b engages. In addition, the tool holding unit 16b comprises at least one operating element 96b for actuating, or moving, the tool holding element 18b.

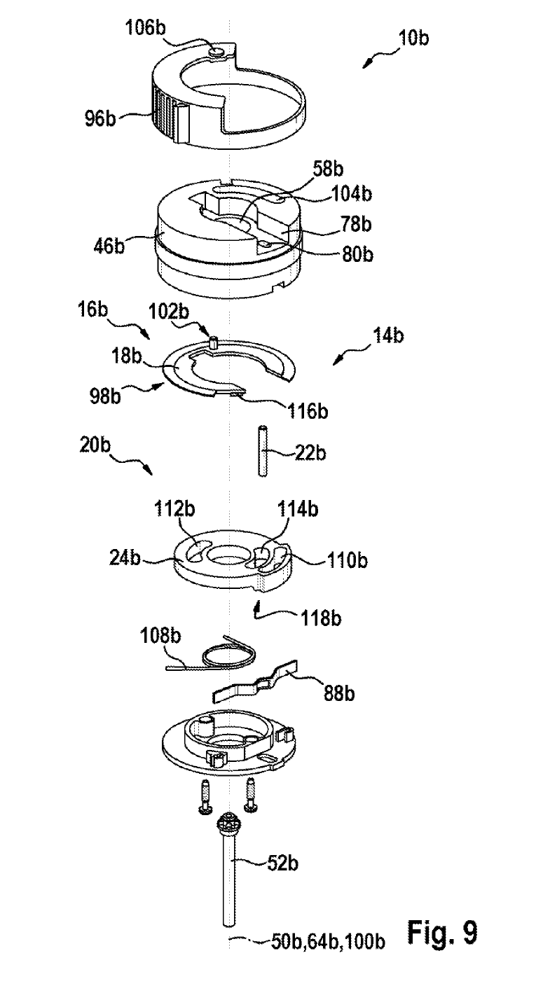

For the purpose of moving the tool holding element 18b, the operating element 96b is rotated about a rotation axis 100b of the operating element 96b. The rotation axis 100b of the operating element 96b in this case is at least substantially parallel to the rotation axis 50b of the drive element 52b. For the purpose of rotationally driving the tool holding element 18b as a result of a rotational movement of the operating element 96b, the tool holding element 18b comprises a stud-type actuating region 102b (FIG. 9). When the tool holding element 18b is in a mounted state, the actuating region 102b is disposed in a movement guide recess 104b of the main body 46b, which movement guide recess is in the shape of a circular-ring segment (FIG. 9). The operating element 96b has a movement transmission element 106b, which is provided to receive the actuating region 102b of the tool holding element 18b. The movement transmission element 106b is realized as a cup-shaped hollow, which is realized so as to correspond to the stud-type actuating region 102b of the tool holding element 18b. It is also conceivable, however, for the movement transmission element 106b to be of another design, considered appropriate by persons skilled in the art, such as, for example, designed as a circular through-hole, etc.

Furthermore, the tool coupling device 10b comprises at least one movement coupling unit 20b, by means of which the tool holding element 18b, for the purpose of moving a tensioning element 22b of the cutting-strand tensioning unit 14b, can be coupled to the tensioning element 22b. The tensioning element 22b in this case is mounted in a translationally movable manner in a guide recess 80b of the main body 46b of the tool coupling device 10b. The movement coupling unit 20b has at least one gate element 24b for moving the tensioning element 22b as a result of a movement of the tool holding element 18b. The gate element 24b in this case is mounted in a rotatable manner. Moreover, the gate element 24b is realized as a gate disk, which has at least one tensioning-element guide gate 110b and at least two gate-element guide recesses 112b, 114b (FIG. 9). In this case, the tensioning element 22b, when in a mounted state, is disposed in the tensioning-element guide gate 110b. The tensioning-element guide gate 110b in this case has a spiral course in relation to the rotation axis 50b of the drive element 52b. In addition, the cutting-strand tensioning unit 14b comprises at least one spring element 88b, which is provided to apply a spring force to the tensioning element 22b (FIGS. 8 and 9). The spring element 88b is realized as a spring plate, which applies a spring force to the tensioning element 22b in the direction of a tensioning position of the tensioning element 22b. The movement coupling unit 20b additionally comprises at least one gate spring element 108b, which is provided to apply a spring force to the gate element 24b (FIGS. 8 and 9). The gate spring element 108b is realized as a leg spring. The gate spring element 108b in this case is supported with one end on the main body 46b and, with another end, the gate spring element 108b is supported on the gate element 24b.

The gate element 24b is moved against the spring force of the gate spring element 108b by means of the tool holding element 18b, or by means of a rotational movement of the operating element 96b, by the tool holding element 18b. For this purpose, the tool holding element 18b has a driving extension 116b, which extends in the direction of the gate element 24b. The driving extension 116b acts in combination with a movement driving region 118b of the gate element 24b for the purpose of moving the gate element 24b (FIG. 9). As a result, the gate element 24b is moved, at least in one direction, in dependence on a movement of the tool holding element 18b, together with the tool holding element 18b. A movement of the gate element 24b causes the tensioning element 22b to be moved, by means of the tensioning-element guide gate 110b, into a guide-unit insertion position. In addition, the tool holding element 18b releases a receiving recess 78b of the main body 46b, for the purpose of receiving the power-tool parting device 12b. The guide recess 80b, in which the tensioning element 22b is guided, is disposed in the region of the receiving recess 78b on the main body 46b.

After the receiving recess 78b has been released and the clamping element 22b has moved into the guide-unit insertion position as a result of a movement of the tool holding element 18b, the power-tool parting device 12b can be inserted in the receiving recess 78b, along a direction that is at least substantially parallel to the rotation axis 50b of the drive element 52b. A rotational movement of the operating element 96b then causes the tool holding element 18b to be moved into a clamping position, causing a clamping force to be exerted upon the power-tool parting device 12b in the direction of the main body 46b. In addition, the gate element 24b is turned as a result of the spring force of the gate spring element 108b, and the tensioning element 22b is moved translationally in the guide recess 80b by means of the tensioning-element guide gate 110b. As a result, a guide unit 36b of the power-tool parting device 12b is moved relative to the drive element 52b. This results in tensioning of a cutting strand 34b of the power-tool parting device 12b by the spring force of the spring element 88b and of the gate spring element 108b, or by the movement of the tensioning element 22b. Thus, automatic tensioning of the cutting strand 34b is effected as a result of the power-tool parting device 12b being clamped in the receiving recess 78b of the main body 46b.

The tensioning-element guide gate 110b in this case is realized in such a manner that, by means of the tensioning-element guide gate 110b acting in combination with the spring element 88b and the gate spring element 108b, a movement of the tensioning element 22b into a guide-unit insertion position is effected in a self-locking manner. Moreover, the gate spring element 108b acts, via the gate element 24b, upon the tool holding element 18b, which, in turn, acts upon the operating element 96b. As a result, the spring force of the gate spring element 108b forces the tool holding element 18b into the clamping position. It is also conceivable, however, for the tool holding element 18b, or the operating element 96b, to be mounted in isolation from the spring force, and to be held in the clamping position by means of a fixing unit of the tool coupling device 10b.

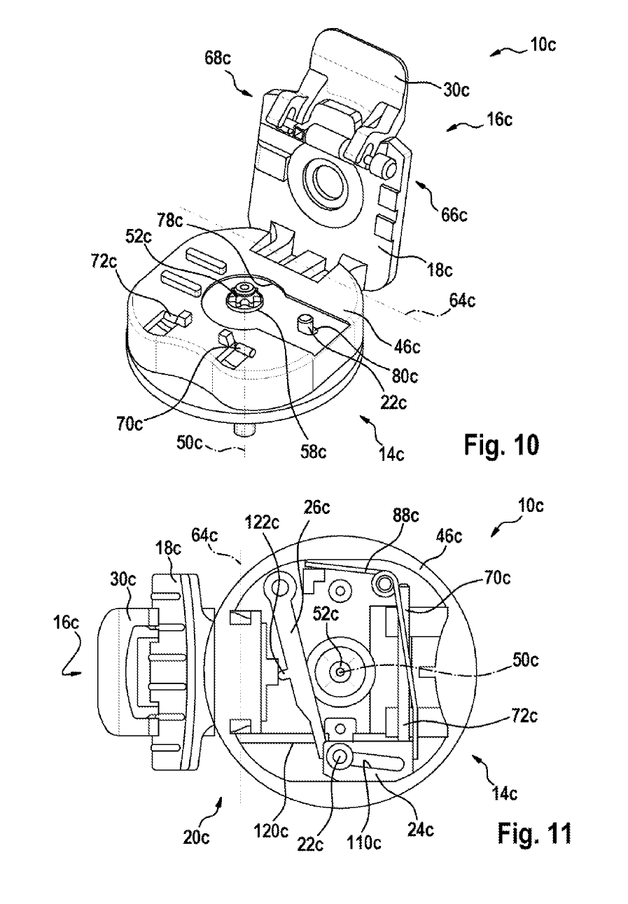

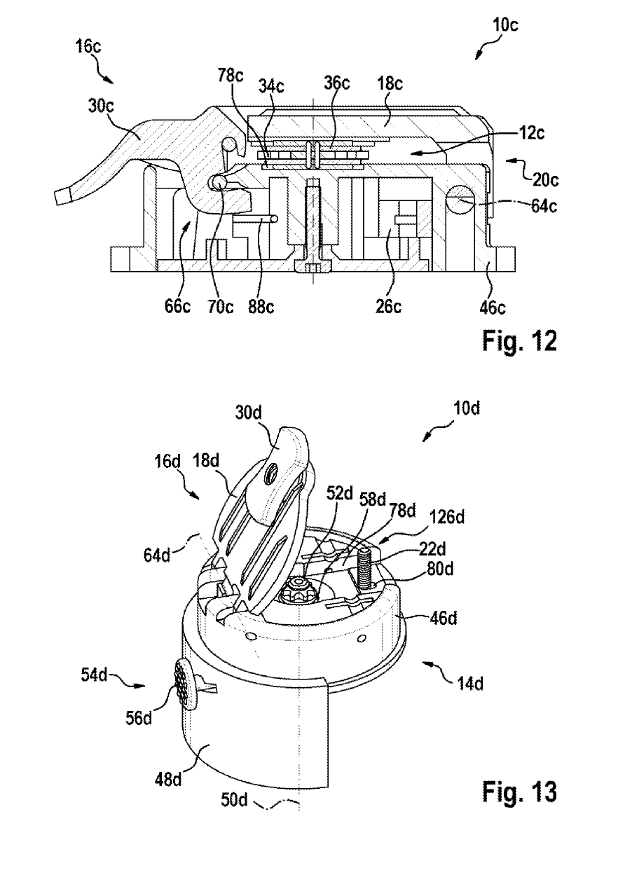

FIG. 10 shows a further, alternative tool coupling device 10c, which is provided to receive a power-tool parting device 12c realized as a closed system (FIG. 12), demounted from a portable power tool (not represented in greater detail here). The portable power tool is of a design similar to that of the portable power tool 32a described in FIGS. 1 to 6.

The portable power tool and the power-tool parting device 12c together form a power tool system. The tool coupling device 10c comprises at least one cutting-strand tensioning unit 14c, for generating a cutting-strand tensioning force, and at least one tool holding unit 16c, which has at least one movably mounted tool holding element 18c. The tool holding element 18c is mounted such that it can be swiveled about an axis of motion 64c of the tool holding element 18c that is at least substantially parallel to a plane of main extent of the tool holding element 18c, or about one that is at least substantially perpendicular to a rotation axis 50c of a drive element 52c of the tool coupling device 10c. The tool coupling device 10c additionally comprises at least one movement coupling unit 20c, by means of which the tool holding element 18c, for the purpose of moving a tensioning element 22c of the cutting-strand tensioning unit 14c, can be coupled to the tensioning element 22c. The movement coupling unit 20c has at least one gate element 24c for moving the tensioning element 22c as a result of a movement of the tool holding element 18c. The gate element 24c is mounted in a translationally movable manner. The gate element 24c in this case is guided in an axial bearing recess 120c of a main body 46c of the tool coupling device 10c (FIG. 11). The gate element 24c comprises a tensioning-element guide gate 110c for moving the tensioning element 22c. The tensioning-element guide gate 110c extends at least substantially transversely in relation to an axis of motion of the gate element 24c. The tensioning-element guide gate 110c is thus sloped relative to the axis of motion of the gate element 24c.

Furthermore, the movement coupling unit 20c comprises at least one lever element 26c, by means of which the tool holding element 18c can be coupled to a gate element 24c of the movement coupling unit 20c, for the purpose of moving the tensioning element 22c. The lever element 26c is mounted in the main body 46c so as to be rotatable about an axis of motion of the lever element 26c that is at least substantially parallel to the rotation axis 50c of the drive element 52c. For the purpose of moving the gate element 24c, the lever element 26c bears with one end against the gate element 24c. In addition, the lever element 26c has an actuating extension 122c, which acts in combination with the tool holding element 18c. Furthermore, the movement coupling unit 20c comprises at least one spring element 88c, which is provided to apply a spring force to the gate element 24c. The spring element 88c is realized as a leg spring. The spring element 88c in this case is supported with one end on the main body 46c and, with another end, the spring element 88c is supported on the gate element 24c. The tool holding unit 16c additionally has at least one fixing element 30c provided to fix the tool holding element 18c in at least one position. The fixing element 30c is of a design similar to that of the fixing element 30a described in FIGS. 1 to 6. The fixing element 30c thus fixes the tool holding element 18c in a tool fixing position of the tool holding element 18c (FIG. 12).

For the purpose of coupling the power-tool parting device 12c to the tool coupling device 10c, the power-tool parting device 12c is inserted in a receiving recess 78c of the main body 46c, along a direction that is at least substantially parallel to the rotation axis 50c of the drive element 52c. The tool holding element 18c in this case is disposed in the position in which it has been swiveled away from the main body 46c. As the power-tool parting device 12c is inserted in the receiving recess 78c, the drive element 52c is inserted in a coupling recess 94c of a guide unit 36c of the power-tool parting device 12c. As a result, a cutting strand 34c of the power-tool parting device 12c engages with the drive element 52c. In addition, the tensioning element 22c is inserted in a tensioning recess 82c of the guide unit 36a. As a result of the tool holding element 18c being moved into the tool fixing position, the tool holding element 18c actuates the lever element 26c by means of an eccentric element 28c of the movement coupling unit 20c that is realized so as to be integral with the tool holding element 18c. As a result, the lever element 26c is swiveled about the axis of motion of the lever element 26c, and actuates the gate element 24c. The gate element 24c in this case is moved translationally. The tensioning element 22c is thus moved into a guide-unit insertion position by the tensioning-element guide gate 110c. In respect of further features of the tool coupling device 10c, reference may be made to the description of FIGS. 1 to 6.

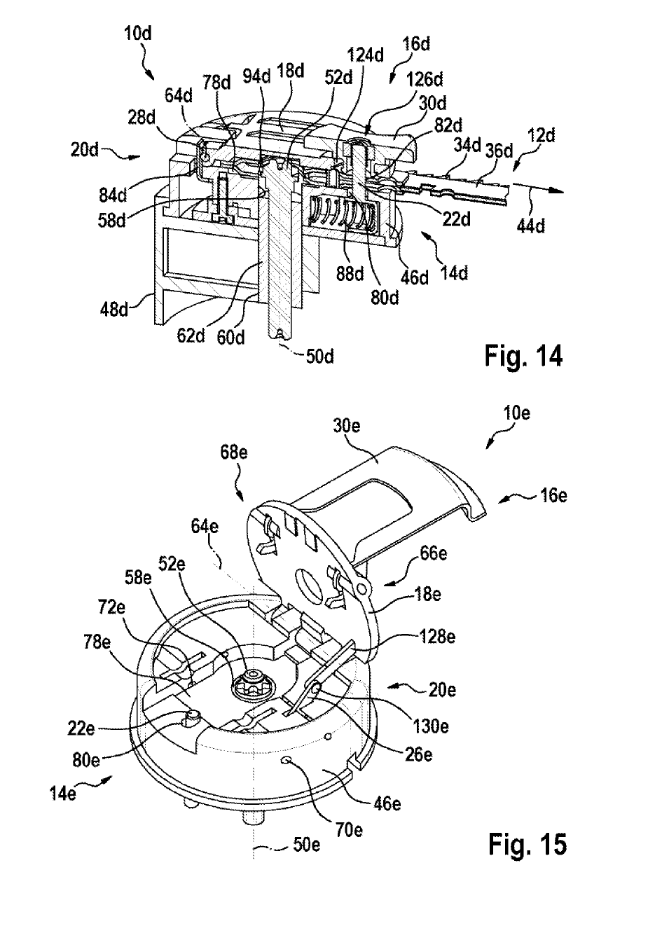

FIG. 13 shows a further, alternative tool coupling device 10d, which is provided to receive a power-tool parting device 12d realized as a closed system (FIG. 14), demounted from a portable power tool (not represented in greater detail here). The portable power tool is of a design similar to that of the portable power tool 32a described in FIGS. 1 to 6. The portable power tool and the power-tool parting device 12d together form a power tool system. The tool coupling device 10d comprises at least one cutting-strand tensioning unit 14d, for generating a cutting-strand tensioning force, and at least one tool holding unit 16d, which has at least one movably mounted tool holding element 18d. The tool holding element 18d is mounted such that it can be swiveled about an axis of motion 64d of the tool holding element 18d that is at least substantially parallel to a plane of main extent of the tool holding element 18d, or about one that is at least substantially perpendicular to a rotation axis 50d of a drive element 52d of the tool coupling device 10d.

The tool coupling device 10d additionally comprises at least one movement coupling unit 20d, by means of which the tool holding element 18d, for the purpose of moving a tensioning element 22d of the cutting-strand tensioning unit 14d, can be coupled to the tensioning element 22d. The movement coupling unit 20d is of a design similar to that of the movement coupling unit 20a described in FIGS. 1 to 6. Furthermore, the tool holding unit 16d has at least one fixing element 30d, which is provided to fix the tool holding element 18d in at least one position. The fixing element 30d in this case is realized as a wing nut. Moreover, the fixing element 30d is mounted in a rotationally and translationally movable manner in a fixing recess 124d of the tool holding element 18d (FIG. 14). For the purpose of fixing the tool holding element 18d, the fixing element 30d acts in combination with a threaded region 126d of the tensioning element 22d. When the tool holding element 18d is moved into a tool fixing position of the tool holding element 18d, the fixing element 30d and the threaded region 126d of the tensioning element 22d are connected to each other. Since the fixing element 30d is disposed in the fixing recess 124d, the tensioning element 22d can move translationally together with the fixing element 30d. In respect of further features of the tool coupling device 10d, reference may be made to the description of FIGS. 1 to 6.

FIG. 15 shows a further, alternative tool coupling device 10e, which is provided to receive a power-tool parting device realized as a closed system (not represented in greater detail here), demounted from a portable power tool (not represented in greater detail here). The portable power tool is of a design similar to that of the portable power tool 32a described in FIGS. 1 to 6. The portable power tool and the power-tool parting device together form a power tool system. The tool coupling device 10e comprises at least one cutting-strand tensioning unit 14e, for generating a cutting-strand tensioning force, and at least one tool holding unit 16e, which has at least one movably mounted tool holding element 18e. The tool holding element 18e is mounted such that it can be swiveled about an axis of motion 64e of the tool holding element 18e that is at least substantially parallel to a plane of main extent of the tool holding element 18e, or about one that is at least substantially perpendicular to a rotation axis 50e of a drive element 52e of the tool coupling device 10e.

The tool coupling device 10e additionally comprises at least one movement coupling unit 20e, by means of which the tool holding element 18e, for the purpose of moving a tensioning element 22e of the cutting-strand tensioning unit 14e, can be coupled to the tensioning element. The movement coupling unit 20e has at least one gate element 24e for moving the tensioning element 22e as a result of a movement of the tool holding element 18e. The gate element 24e is mounted in a rotatable manner. The gate element 24e in this case is mounted in a rotatable manner in a main body 46e of the tool coupling device 10e. The gate element 24e additionally has at least one tensioning-element guide gate 110e for moving the tensioning element 22e as a result of a movement of the tool holding element 18e. The movement coupling unit 20e additionally comprises at least one lever element 26e that, as a result of a movement of the tool holding element 18e, moves the gate element 24e for the purpose of moving the tensioning element 22e. The lever element 26e in this case is mounted in the main body 46e such that it can be swiveled about an axis of motion of the lever element 26e. The axis of motion of the lever element 26e in this case is at least substantially parallel to the axis of motion 64e of the tool holding element 18e. Moreover, the movement coupling unit 20e has a force transfer element 128e, which is mounted in a swiveling manner on the tool holding element 18e. In addition, the force transfer element 128e is connected in a swiveling manner to the lever element 26e, by means of a link element 130e. The link element 130e in this case is realized as a hinge pin, which engages in a link eye of the lever element 26e and of the force transfer element 128e, respectively.

Furthermore, the movement coupling unit 20e comprises at least one spring element 88e, which is provided to apply a spring force to the gate element 24e. The spring element 88e is realized as a leg spring. The spring element 88e in this case is supported with one end on the main body 46e and, with another end, the spring element 88e is supported on the gate element 24e. As a result of the tool holding element 18e moving into a tool fixing position of the tool holding element 18e, in the direction of the main body 46e, the lever element 26e is actuated by means of the force transfer element 128e. As a result, the lever element 26e releases the gate element 24e. The gate element 24e is moved by the spring force of the spring element 88e. As a result, the tensioning element 22e is moved into a tensioning position of the tensioning element 22e by means of the tensioning-element guide gate 110e. In respect of further features of the tool coupling device 10e, reference may be made to the description of FIGS. 1 to 6.

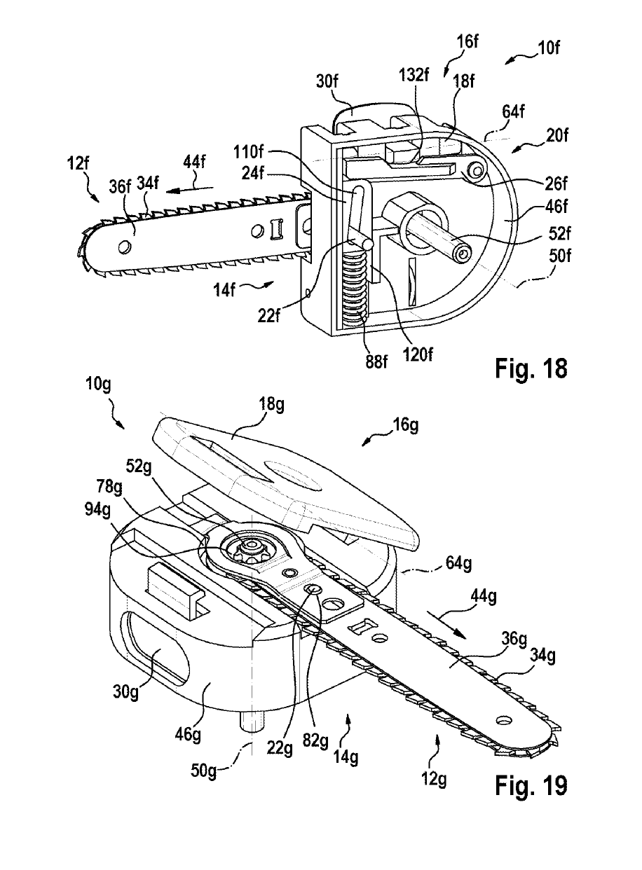

FIG. 17 shows a further, alternative tool coupling device 10f, which is provided to receive a power-tool parting device 12f realized as a closed system (FIG. 18), demounted from a portable power tool (not represented in greater detail here). The portable power tool is of a design similar to that of the portable power tool 32a described in FIGS. 1 to 6. The portable power tool and the power-tool parting device 12f together form a power tool system. The tool coupling device 10f has at least one cutting-strand tensioning unit 14f, for generating a cutting-strand tensioning force, and at least one tool holding unit 16f, which has at least one movably mounted tool holding element 18e. The tool holding element 18f is mounted such that it can be swiveled about an axis of motion 64f of the tool holding element 18f that is at least substantially parallel to a plane of main extent of the tool holding element 18f, or about one that is at least substantially perpendicular to a rotation axis 50f of a drive element 52f of the tool coupling device 10f.

The tool coupling device 10f additionally comprises at least one movement coupling unit 20f, by means of which the tool holding element 18f, for the purpose of moving a tensioning element 22f of the cutting-strand tensioning unit 14f, can be coupled to the tensioning element 22f. The movement coupling unit 20f has at least one gate element 24f for moving the tensioning element 22f as a result of a movement of the tool holding element 18f. The gate element 24f is mounted in a translationally movable manner. In this case, the gate element 24f is guided in an axial bearing recess 120f of a main body 46f of the tool coupling device 10f (FIG. 18). The gate element 24f comprises a tensioning-element guide gate 110f, for moving the tensioning element 22f. The tensioning-element guide gate 110f extends at least substantially transversely in relation to an axis of motion of the gate element 24f. The tensioning-element guide gate 110f is thus sloped relative to the axis of motion of the gate element 24f.

The movement coupling unit 20f additionally comprises at least one lever element 26f that, as a result of a movement of the tool holding element 18f, moves the gate element 24f for the purpose of moving the tensioning element 22f. The lever element 26f is mounted in the main body 46f so as to be rotatable about an axis of motion of the lever element 26f that is at least substantially parallel to the rotation axis 50f of the drive element 52f. For the purpose of moving the gate element 24f, the lever element 26f bears with one end against the gate element 24f. In addition, the lever element 26f has a pressure region 132f, which acts in combination with the tool holding element 18f. Furthermore, the movement coupling unit 20f comprises at least one spring element 88f, which is provided to apply a spring force to the gate element 24f of the movement coupling unit 20f. The spring element 88f is realized as a helical compression spring. The spring element 88f in this case is supported with one end on the main body 46f and, with another end, the spring element 88f is supported on the gate element 24f. The spring element 88f is disposed in the axial bearing recess 120f of the main body 46f. In respect of further features of the tool coupling device 10f, reference may be made to the description of FIGS. 1 to 6.

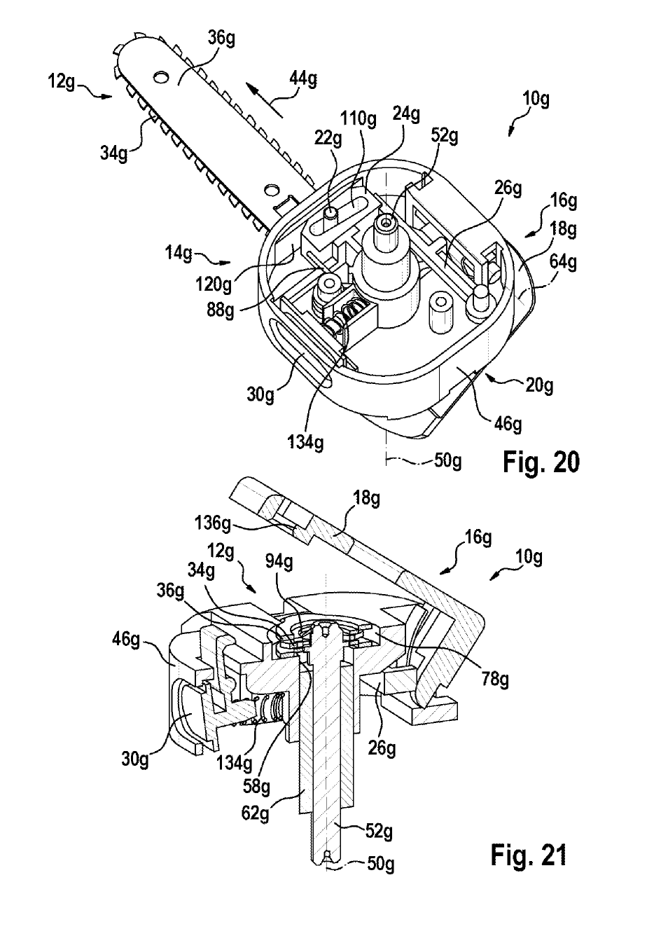

FIG. 19 shows a further, alternative tool coupling device 10g, which is provided to receive a power-tool parting device 12g realized as a closed system, demounted from a portable power tool (not represented in greater detail here). The portable power tool is of a design similar to that of the portable power tool 32a described in FIGS. 1 to 6. The portable power tool and the power-tool parting device 12g together form a power tool system. The design of the tool coupling device 10g is at least substantially similar to that of the tool coupling device 10f described in FIGS. 17 and 18. Unlike the tool coupling device 10f, a movement coupling unit 20g of the tool coupling device 10g has a spring element 88g realized as a leg spring. In addition, a tool holding unit 16g of the tool coupling device 10g has at least one fixing element 30g provided to fix a tool holding element 18g in at least one position. The fixing element 30g is mounted in a swiveling manner in a main body 46g of the tool coupling device 10g (FIG. 21). The tool holding unit 16g additionally has a fixing spring element 134g, which is provided to apply a spring force to the fixing element 30g (FIGS. 20 and 21). The fixing element 30g is thus realized as a spring-biased latching hook, which acts in combination with a fixing extension 136g disposed in the tool holding element 18g, for the purpose of fixing the tool holding element 18g in a tool fixing position (FIG. 21). The fixing extension 136g in this case is realized so as to be integral with the tool holding element 18g.

1. A tool coupling device for receiving a power-tool parting device, the tool coupling device comprising:
at least one cutting-strand tensioning unit configured to generate a cutting-strand tensioning force;
at least one tool holding unit including at least one movably mounted tool holding element; and
at least one movement coupling unit configured to couple the at least one movably mounted tool holding element to of the at least one cutting-strand tensioning unit to move the tensioning element.

2. The tool coupling device as claimed in claim 1, wherein the at least one movement coupling unit has at least one gate element configured to move the tensioning element as a result of a movement of the at least one movably mounted tool holding element.

3. The tool coupling device as claimed in claim 2, wherein the at least one gate element is mounted in a translationally movable manner.

4. The tool coupling device at least as claimed in claim 2, wherein the at least one gate element is mounted in a rotatable manner.

5. The tool coupling device as claimed in claim 1, wherein the at least one movement coupling unit includes at least one lever element configured to couple the at least one movably mounted tool holding element to a gate element of the at least one movement coupling unit to move the tensioning element.

6. The tool coupling device as claimed in claim 1, wherein the at least one movement coupling unit includes at least one eccentric element integral with the at least one movably mounted tool holding element.

7. The tool coupling device as claimed in claim 1, wherein the at least one tool holding unit has at least one fixing element configured to fix the at least one movably mounted tool holding element in at least one position.

8. The tool coupling device at least as claimed in claim 7, wherein the at least one fixing element is mounted in a swiveling manner.

9. A portable power tool, comprising:
a tool coupling device, including:
at least one cutting-strand tensioning unit configured to generate a cutting-strand tensioning force;
at least one tool holding unit including at least one movably mounted tool holding element; and
at least one movement coupling unit configured to couple the at least one movably mounted tool holding element to a tensioning element of the at least one cutting-strand tensioning unit to move the tensioning element.

10. A power tool system, comprising:
at least one portable power tool, including:
at least one cutting-strand tensioning unit configured to generate a cutting-strand tensioning force;
at least one tool holding unit including at least one movably mounted tool holding element; and
at least one movement coupling unit configured to couple the at least one movably mounted tool holding element to a tensioning element of the at least one cutting-strand tensioning unit to move the tensioning element; and
at least one power-tool parting device, which has including at least one cutting strand and at least one guide unit that, together with the at least one cutting strand, forms a closed system.
